(19) United States
(12) Patent Application Publication
(10) Pub. No.: US 2020/0188224 A1
(43) Pub. Date: Jun. 18, 2020

(54) Massage Vest Assembly

(71) Applicant: Cindy Mountjoy, Stockton, CA (US)

(72) Inventor: Cindy Mountjoy, Stockton, CA (US)

(21) Appl. No.: 16/220,790

(22) Filed: Dec. 14, 2018

(51) Int. Cl. A61H 23/02

(52) U.S. Cl. CPC A61H 23/02; A61H 2201/5038; A61H 2201/1619; A61H 2201/165

(57) ABSTRACT

A massage vest assembly for providing automatic therapeutic massage includes a vest that is worn on a user's torso. A plurality of massage units is each coupled to the vest to engage and thusly massage the user's torso when the vest is worn. The plurality of massage units includes a set of shoulder massage units and a set of spine massage units. A control is provided and the control is positionable within a respective one of the pockets. The control is electrically coupled to each of the massage units such that the control unit turns each of the massage units on and off.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to massage devices and more particularly pertains to a new massage device for providing automatic therapeutic massage.

### BRIEF SUMMARY OF THE INVENTION

An embodiment of the disclosure meets the needs presented above by generally comprising a vest that is worn on a user's torso. A plurality of massage units is each coupled to the vest to engage and thusly massage the user's torso when the vest is worn. The plurality of massage units includes a set of shoulder massage units and a set of spine massage units. A control is provided and the control is positionable within a respective one of the pockets. The control is electrically coupled to each of the massage units such that the control unit turns each of the massage units on and off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front phantom view of a massage vest assembly according to an embodiment of the disclosure.

FIG. 2 is a right side phantom view of an embodiment of the disclosure.

FIG. 3 is a back phantom view of an embodiment of the disclosure.

FIG. 4 is a perspective view of a control and a battery charger of an embodiment of the disclosure.

FIG. 5 is a perspective in-use view of an embodiment of the disclosure.

FIG. 6 is a cross sectional view taken from line 6-6 of FIG. 3 of an embodiment of the disclosure.

### DETAILED DESCRIPTION OF THE INVENTION

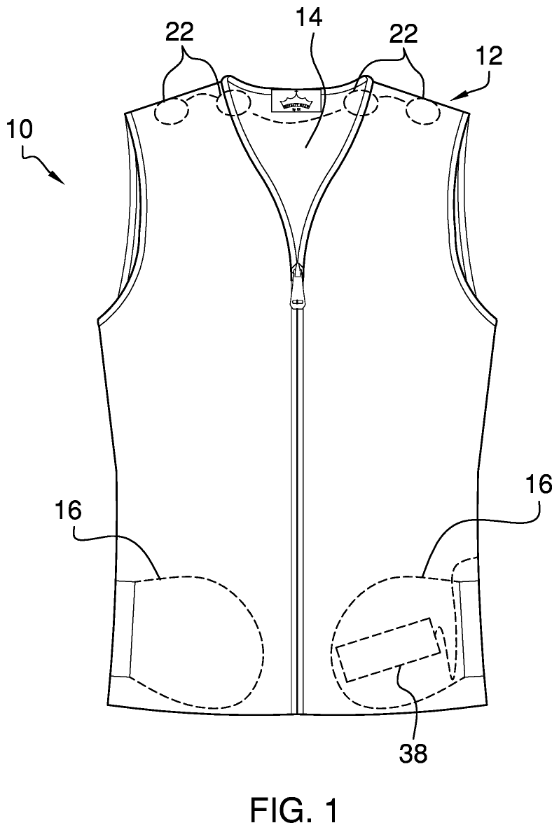

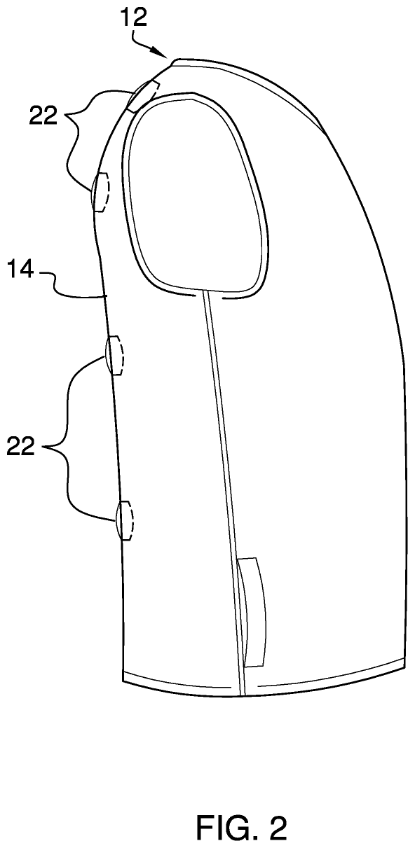

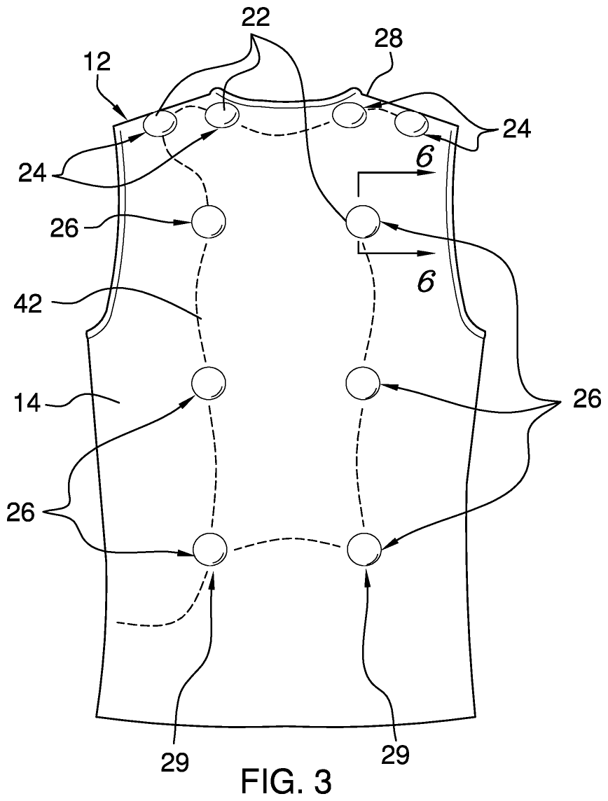

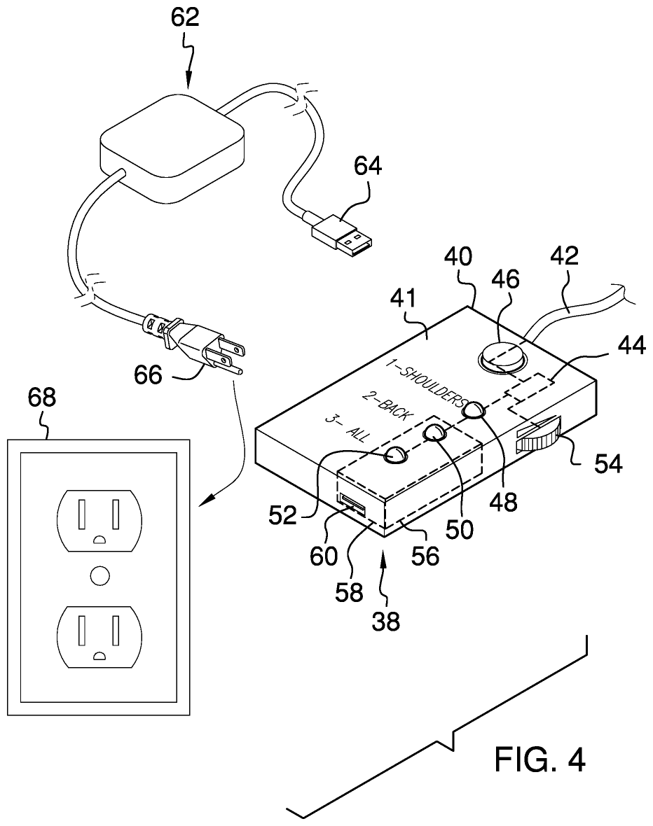

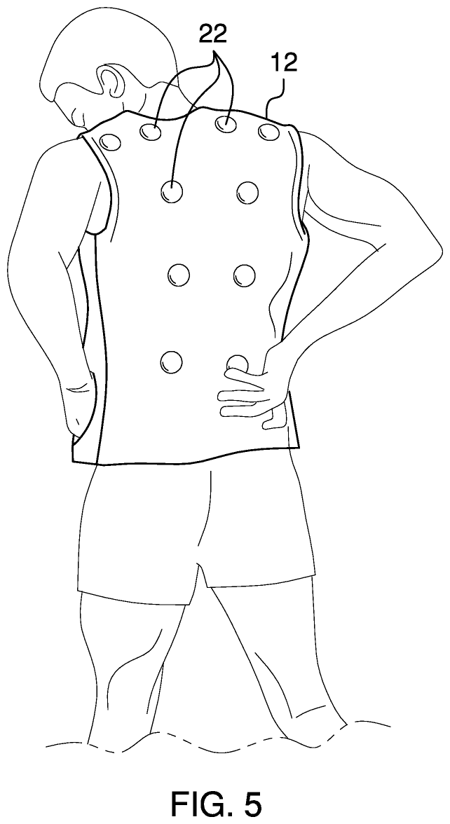

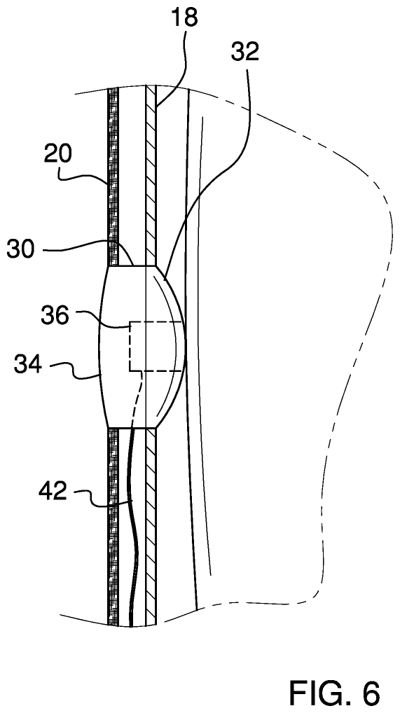

With reference now to the drawings, and in particular to FIGS. 1 through 6 thereof, a new massage device embodying the principles and concepts of an embodiment of the disclosure and generally designated by the reference numeral 10 will be described.

As best illustrated in FIGS. 1 through 6, the massage vest assembly 10 generally comprises a vest 12 that is worn on a user's torso. The vest 12 has a rear panel 14 that is positioned on the user's back when the vest 12 is worn and a pair of pockets 16. Additionally, the vest 12 comprises an inner layer 18 that is spaced from an outer layer 20, and the inner layer 18 abuts the user when the vest 12 is worn. The vest 12 may have an open front with a zipper or other type of closure.

A plurality of massage units 22 is each coupled to the vest 12 and engages the user's torso when the vest 12 is worn. Each of the massage units 22 vibrates when the massage units 22 are turned on thereby massaging the user's torso when the vest 12 is worn. Each of the massage units 22 is positioned on the rear panel 14 of the vest 12, and the plurality of massage units 22 includes a set of shoulder massage units 24 and a set of spine massage units 26. The shoulder massage units 24 are spaced apart from each other and are distributed along an upper end 28 of the rear panel 14. Thus, the shoulder massage units 24 engage the user's shoulders and lower neck when the vest 12 is worn. The spine massage units 26 are spaced apart from each other and are arranged to form a pair of vertically oriented lines 29 on the rear panel 14. Each of the vertically oriented lines 29 is offset from a center of the rear panel 14 and extend along each side of the user's spine when the vest 12 is worn.

Each of the massage units 22 comprises a housing 30 that is integrated into the rear panel 14 of the vest 12. The housing 30 has a front surface 32 and a back surface 34, and the front surface 32 is concavely arcuate with respect to the back surface 34 such that the front surface 32 has a hemispherical shape. Moreover, the front surface 32 extends through the inner layer 18 of the vest 12 to engage the user's body when the vest 12 is worn. A vibrating unit 36 is positioned within the housing 30 and the vibrating unit 36 engages the front surface 32 of the housing 30. The vibrating unit 36 vibrates the front surface 32 when the vibrating unit 36 is turned on to massage the user's body when the vest 12 is worn. The vibrating unit 36 may be an electro-mechanical vibrator or the like.

A control 38 is provided and the control 38 is positionable within a respective one of the pockets 16. The control 38 is electrically coupled to each of the massage units 22 such that the control 38 unit turns each of the massage units 22 on and off. The control 38 comprises a box 40 that has a front wall 41 and a conductor 42 that is coupled between the box 40 and each of the massage units 22. The conductor 42 is electrically coupled to the vibrating unit 36 in each of the massage units 22, and the conductor 42 is positioned between the inner 18 and outer 20 layers of the vest 12.

A control circuit 44 is positioned within the box 40 and the control circuit 44 is electrically coupled to the conductor 42. Thus, the control circuit 44 is in electrical communication with the vibrating unit 36 in each of the massage units 22. A power button 46 is movably coupled to the front wall 41 of the box 40 and the power button 46 is electrically coupled to the control circuit 44 for turning the control circuit 44 on and off. A shoulder button 48 is movably coupled to the front wall 41 of the box 40, the shoulder button 48 is electrically coupled to the control circuit 44 and only the shoulder massage units 24 are turned on when the shoulder button 48 is manipulated. A back button 50 is movably coupled to the front wall 41 of the box 40, the back button 50 is electrically coupled to the control circuit 44 and only the spine massage units 26 are turned on when the back button 50 is manipulated. An all button 52 is movably coupled to the front wall 41 of the box 40, the all button 52 is electrically coupled to the control circuit 44 and all of the neck massage units 22 and all of the spine massage units 26 are turned on when the all button 52 is manipulated.

An intensity wheel 54 is rotatably coupled to the box 40 and the intensity wheel 54 extends outwardly from the box 40 such that the intensity wheel 54 can be rotated. The intensity wheel 54 is electrically coupled to the control circuit 44, and the intensity wheel 54 is rotatable in an increasing direction or a decreasing direction. The control circuit 44 actuates each of the massage units 22 to increase vibration toward a maximum intensity when the intensity wheel 54 is rotated in the increasing direction. Alternatively, the control circuit 44 actuates each of the massage units 22 to decrease vibration toward a minimum intensity when the intensity wheel 54 is rotated in the decreasing direction.

A power supply 56 is coupled to the box 40 and the power supply 56 is electrically coupled to the control circuit 44. The power supply 56 comprises at least one rechargeable battery 58 that is positioned within the box 40, and the at least one rechargeable battery 58 is electrically coupled to the control circuit 44. A charge port 60 is coupled to the box 40 and the charge port 60 is electrically coupled to the at least one rechargeable battery 58. The charge port 60 may be a usb port or other similar electronic port. A battery charger 62 is included that has a first plug 64 and a second plug 66. The first plug 64 is pluggable into the charge port 60 and the second plug 66 is pluggable into a power source 68 for charging the at least one battery 58. The first plug 64 may be a usb plug or the and the second plug 66 may be a male electrical plug for plugging into a female electrical outlet.

In use, the vest 12 is worn when the user needs to relieve muscle tension or to treat symptoms of a neck or back injury. The power button 46 on the control 38 is manipulated to turn on each of the massage units 22. Thus, each of the massage units 22 massages the user's shoulders and back while the vest 12 is worn. Additionally, the shoulder button 48 or the back button 50 can be manipulated to massage only the user's shoulders or the user's back. The intensity wheel 54 can be rotated to either increase or decrease the intensity with which the massage units 22 massage the user. Additionally, the battery charger 62 can be plugged into the charge port 60 when the vest 12 is not being worn for recharging the at least one rechargeable battery 58.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A massage vest assembly being configured to massage a user while the user wears said assembly, said assembly comprising:
a vest being worn on a user's torso, said vest having a rear panel being positioned on the user's back when said vest is worn and a pair of pocket;
a plurality of massage units, each of said massage units being coupled to said vest wherein each of said massage units is configured to engage the user's torso when said vest is worn, each of said massage units vibrating when said massage units are turned on wherein each of said massage units is configured to massage the user's torso when said vest is worn, each of said massage units being positioned on said rear panel of said vest, said plurality of massage units including a set of shoulder massage units and a set of spine massage units, said shoulder massage units being spaced apart from each other and being distributed along an upper end of said rear panel wherein said shoulder massage units are configured to engage the user's shoulders and lower neck when said vest is worn, said spine massage units being spaced apart from each other and being arranged to form a pair of vertically oriented lines on said rear panel, each of said vertically oriented lines being offset from a center of said rear panel wherein said plurality of spine massage units is configured to extend along each side of the user's spine when said vest is worn; and
a control being positionable within a respective one of said pockets, said control being electrically coupled to each of said massage units such that said control unit turns each of said massage units on and off.

2. The assembly according to claim 1, wherein:
said vest comprises an inner layer being spaced from an outer layer, said inner layer abutting the user when said vest is worn; and
each of said massage units comprises a housing being integrated into said rear panel of said vest, said housing having a front surface and a back surface, said front surface being concavely arcuate with respect to said back surface such that said front surface has a hemispherical shape, said front surface extending through said inner layer of said vest wherein said front surface is configured to engage the user's body when said vest is worn.

3. The assembly according to claim 2, wherein each of said massage units comprises a vibrating unit being positioned within said housing, said vibrating unit engaging said front surface of said housing, said vibrating unit vibrating said front surface when said vibrating unit is turned on wherein said front surface is configured to massage the user's body when said vest is worn.

4. The assembly according to claim 3, wherein said control comprises:
a box having a front wall;
a conductor being coupled between said box and each of said massage units, said conductor being electrically coupled to said vibrating unit in each of said massage units;
a control circuit being positioned within said box, said control circuit being electrically coupled to said conductor such that said control circuit is in electrical communication with said vibrating unit in each of said massage units; and
a power button being movably coupled to said front wall of said box, said power button being electrically coupled to said control circuit, said power button turning said control circuit on and off;

5. The assembly according to claim 4, further comprising:
a shoulder button being movably coupled to said front wall of said box, said shoulder button being electrically coupled to said control circuit, only said shoulder massage units being turned on when said shoulder button is manipulated;
a back button being movably coupled to said front wall of said box, said back button being electrically coupled to said control circuit, only said spine massage units being turned on when said back button is manipulated; and
an all button being movably coupled to said front wall of said box, said all button being electrically coupled to said control circuit, all of said neck massage units and all of said spine massage units being turned on when said all button is manipulated.

6. The assembly according to claim 4, further comprising an intensity wheel being rotatably coupled to said box, said intensity wheel extending outwardly from said box wherein said intensity wheel is configured to be rotated, said intensity wheel being electrically coupled to said control circuit, said intensity wheel being rotatable in an increasing direction or a decreasing direction, said control circuit actuating each of said massage units to increase vibration toward a maximum intensity when said intensity wheel is rotated in said increasing direction, said control circuit actuating each of said massage units to decrease vibration toward a minimum intensity when said intensity wheel is rotated in said decreasing direction.

7. The assembly according to claim 4, further comprising a power supply being coupled to said box, said power supply being electrically coupled to said control circuit, said power supply comprising:
at least one battery being positioned within said box, said at least one battery being electrically coupled to said control circuit;
a charge port being coupled to said box, said charge port being electrically coupled to said at least one battery; and
a battery charger having a first plug and a second plug, said first plug being pluggable into said charge port, said second plug being pluggable into a power source for charging said at least one battery.

8. A massage vest assembly being configured to massage a user while the user wears said assembly, said assembly comprising:
a vest being worn on a user's torso, said vest having a rear panel being positioned on the user's back when said vest is worn and a pair of pocket, said vest comprising an inner layer being spaced from an outer layer, said inner layer abutting the user when said vest is worn;
a plurality of massage units, each of said massage units being coupled to said vest wherein each of said massage units is configured to engage the user's torso when said vest is worn, each of said massage units vibrating when said massage units are turned on wherein each of said massage units is configured to massage the user's torso when said vest is worn, each of said massage units being positioned on said rear panel of said vest, said plurality of massage units including a set of shoulder massage units and a set of spine massage units, said shoulder massage units being spaced apart from each other and being distributed along an upper end of said rear panel wherein said shoulder massage units are configured to engage the user's shoulders and lower neck when said vest is worn, said spine massage units being spaced apart from each other and being arranged to form a pair of vertically oriented lines on said rear panel, each of said vertically oriented lines being offset from a center of said rear panel wherein said plurality of spine massage units is configured to extend along each side of the user's spine when said vest is worn, each of said massage units comprising:
a housing being integrated into said rear panel of said vest, said housing having a front surface and a back surface, said front surface being concavely arcuate with respect to said back surface such that said front surface has a hemispherical shape, said front surface extending through said inner layer of said vest wherein said front surface is configured to engage the user's body when said vest is worn; and
a vibrating unit being positioned within said housing, said vibrating unit engaging said front surface of said housing, said vibrating unit vibrating said front surface when said vibrating unit is turned on wherein said front surface is configured to massage the user's body when said vest is worn; and
a control being positionable within a respective one of said pockets, said control being electrically coupled to each of said massage units such that said control unit turns each of said massage units on and off, said control comprising:
a box having a front wall;
a conductor being coupled between said box and each of said massage units, said conductor being electrically coupled to said vibrating unit in each of said massage units;
a control circuit being positioned within said box, said control circuit being electrically coupled to said conductor such that said control circuit is in electrical communication with said vibrating unit in each of said massage units;
a power button being movably coupled to said front wall of said box, said power button being electrically coupled to said control circuit, said power button turning said control circuit on and off;
a shoulder button being movably coupled to said front wall of said box, said shoulder button being electrically coupled to said control circuit, only said shoulder massage units being turned on when said shoulder button is manipulated;
a back button being movably coupled to said front wall of said box, said back button being electrically coupled to said control circuit, only said spine massage units being turned on when said back button is manipulated;
an all button being movably coupled to said front wall of said box, said all button being electrically coupled to said control circuit, all of said neck massage units and all of said spine massage units being turned on when said all button is manipulated;
an intensity wheel being rotatably coupled to said box, said intensity wheel extending outwardly from said box wherein said intensity wheel is configured to be rotated, said intensity wheel being electrically coupled to said control circuit, said intensity wheel being rotatable in an increasing direction or a decreasing direction, said control circuit actuating each of said massage units to increase vibration toward a maximum intensity when said intensity wheel is rotated in said increasing direction, said control circuit actuating each of said massage units to decrease vibration toward a minimum intensity when said intensity wheel is rotated in said decreasing direction; and
a power supply being coupled to said box, said power supply being electrically coupled to said control circuit, said power supply comprising:
at least one battery being positioned within said box, said at least one battery being electrically coupled to said control circuit;
a charge port being coupled to said box, said charge port being electrically coupled to said at least one battery; and
a battery charger having a first plug and a second plug, said first plug being pluggable into said charge port, said second plug being pluggable into a power source for charging said at least one battery.
